(19) United States
(12) Patent Application Publication
(10) Pub. No.: US 2009/0010226 A1
(43) Pub. Date: Jan. 8, 2009

(54) Communication Terminal, Access Point Switching Method, and Access Point Switching Control Program

(76) Inventors: Yasunori Nishimura, Tokyo (JP); Shinichi Morimoto, Tokyo (JP); Youko Oomori, Tokyo (JP)

Correspondence Address: NEC CORPORATION OF AMERICA, 6535 N. STATE HWY 161, IRVING, TX, 75039, US

(21) Appl. No.: 12/281,355

(22) PCT Filed: Mar. 1, 2007
(86) PCT No.: PCT/JP2007/053880

§ 371 Date: Sep. 2, 2008

(30) Foreign Application Priority Data
Mar. 1, 2006 (JP) 2006-055300

(51) Int. Cl. H04Q 7/00

(52) U.S. Cl. 370/331

(57) ABSTRACT

[Subject] To realize optimum handover in consideration of not only reception environment of a communication terminal itself but also situations on the other party of communication.

[Solving Means] A communication terminal includes: a reception environment information measuring unit for measuring information of reception environment around an access point; a transmission environment information measuring unit for measuring information of transmission environment around the access point; an access point search timing determining unit for determining a timing of searching for an access point to which the communication terminal is to be switched by using a combination of the measured reception environment information and transmission environment information; an access point searching unit for searching for an access point to which the communication terminal is to be switched at the access point search timing determined; a handover timing determining unit for determining a timing of handover to the access point to which the communication terminal is to be switched by using a combination of the measured reception environment information and transmission environment information; and a handover unit for performing handover to the searched access point at the determined handover timing.

### TECHNICAL FIELD

The present invention relates to a communication terminal that searches for an access point and switches the access point during travel (movement), an access point switching method used at the time of switching an access point, and an access point switching control program.

### BACKGROUND ART

In radio communication such as a wireless LAN (Local Area Network), it is unnecessary to connect a cable to a destination of communication. The wireless communication is therefore widely used by mobile communication terminals. A plurality of access points are attached to telephone poles and electronic equipment installed outdoors to cover a wide range by radio. Except for such a wireless LAN, each of a cellular phone and a PHS (Personal Handy-phone System) also uses a plurality of access points as wireless base stations, thereby realizing wireless communication in a wide area.

In the case where a communication terminal travels (moves) in a wide-area wireless communication system in which access points are disposed in various places, to perform radio communication always in the best conditions, switching of the access point (handover) is necessary. For this purpose, an access point to which the communication terminal is to be switched is searched for.

In a conventional access point switching system, the reception level of an electric wave from an access point with which a communication terminal is performing communication at present is checked. When the reception level becomes lower than a threshold of handover which is set, a link channel establishment request is sent to another access point. In such handover, however, when the travel speed of the communication terminal increases to some extent and above, a problem occurs such that the distance between the communication terminal and the present access point becomes too long before the handover is carried out, and the communication is disconnected. To address the problem, a technique of detecting the travel speed (moving speed) of the communication terminal and changing the threshold of the handover in accordance with the detected speed has been proposed (refer to, for example, Patent Document 1).

FIG. 10 shows the outline of an access point switch control method in the proposal. In the proposal, a communication terminal detects the reception level from an access point in predetermined time intervals (step S101) and stores detected reception levels in time series into a level storage area in the communication terminal (step S102). A reception level fluctuation amount is computed from the reception levels stored in the level storage area (step S103). Whether the fluctuation amount is equal to or larger than a predetermined value or not is determined (step S104).

In the case where the fluctuation amount is equal to or larger than the predetermined value (YES), it is estimated that the speed of travel of the communication terminal is relatively high. In this case, a high threshold of the reception level is selected so that handover is easily performed (step S105), and a handover process for handing the access point to the next access point is performed (step S106). In the case where the fluctuation amount is less than the predetermined value (NO in step S104), a low threshold is selected (step S107), and the handover process is performed (step S106).

FIG. 11 shows the relation between the distance from an access point and the reception level described in the patent document 1 as the base of the proposal. Generally, the electric field strength decreases in inverse proportion to the fourth power of the distance from an access point as an electric wave emission point. Therefore, in environment such that an access point exists in middle of a flat land where no facility exists, the reception level simply decreases with distance from the access point as shown in FIG. 11. In such communication environment, it is effective to change the reception level at the time of handover in accordance with the travel speed of the communication terminal.

Patent Document 1: JP-A 2000-197093 (Japanese Unexamined Patent Application Publication No. 2000-197093) (paragraphs 0024 and 0027, FIGS. 3 and 5A)

### DISCLOSURE OF THE INVENTION

### Problem to be Solved by the Invention

In reality, however, such simple communication environments are rare. For example, it is assumed that a source of generating noise having the same frequency as that of a frequency used by a communication terminal exists in a position close to an access point. The case where another communication terminal performs communication near an access point may correspond to such a situation. In this case, similarly, the reception level of the communication terminal decreases with distance from the access point. On the other hand, there is a case such that an electric wave transmitted from a communication terminal to an access point is disturbed by noise of another communication terminal and the reception characteristic of the access point deteriorates. It can be also regarded as deterioration in the transmission characteristic of the communication terminal.

The above case is just an example. Only by adjusting a threshold by using a reception level of a communication terminal, in some cases, handover cannot be carried out accurately and communication is interrupted.

An object of the present invention is to provide a communication terminal, an access point switching method, and an access point switching control program capable of properly performing handover under various communication environments.

### Means for Solving the Problem

A communication terminal of the present invention includes: a reception environment information measuring unit for measuring information of reception environment between the communication terminal and an access point; a transmission environment information measuring unit for measuring information of transmission environment between the communication terminal and the access point; an access point search timing determining unit for determining a timing of searching for an access point to be switched by using a combination of the reception environment information measured by the reception environment information measuring unit and the transmission environment information measured by the transmission environment information measuring unit; an access point searching unit for searching for the access point to be switched at the access point search timing determined by the access point search timing determining unit; a handover timing determining unit for determining a timing of handover to the access point to be switched by using a combination of the reception environment information measured by the reception environment information measuring unit and the transmission environment information measured by the transmission environment information measuring unit; and a handover unit for performing handover to the access point searched by the access point searching unit at the handover timing determined by the handover timing determining unit.

A method of switching an access point in a communication terminal, of the present invention includes: a reception environment information measuring process for measuring information of reception environment between the communication terminal and the access point; a transmission environment information measuring process for measuring information of transmission environment between the communication terminal and the access point; an access point search timing determining process for determining a timing of searching for an access point to which the communication terminal is switched by using a combination of the reception environment information measured in the reception environment information measuring process and the transmission environment information measured in the transmission environment information measuring process; an access point searching process for searching the access point to which the communication terminal is to be switched at the determined access point searching timing; a handover timing determining process for determining a timing of handover to the access point to which the communication terminal is to be switched by using a combination of the reception environment information measured in the reception environment information measuring process and the transmission environment information measured in the transmission environment information measuring process; and a handover process for performing handover to the access point searched by the access point searching process at the handover timing determined by the handover timing determining process.

An access point switching control program for making a computer as a communication terminal for performing communication with an access point execute: a reception environment information measuring process for measuring information of reception environment between the communication terminal and the access point; a transmission environment information measuring process for measuring information of transmission environment between the communication terminal and the access point; an access point search timing determining process for determining a timing of searching for an access point to which the communication terminal is to be switched of the communication terminal by using a combination of the reception environment information measured in the reception environment information measuring process and the transmission environment information measured in the transmission environment information measuring process; an access point searching process for searching for the access point to which the communication terminal is to be switched at the determined access point search timing; a handover timing determining process for determining a timing of handover to the access point to which the communication terminal is to be switched by using a combination of the reception environment information measured in the reception environment information measuring process and the transmission environment information measured in the transmission environment information measuring process; and a handover process for performing handover to the access point searched by the access point searching process at the handover timing determined by the handover timing determining process.

### EFFECT OF THE INVENTION

In the present invention, both the reception environment and the transmission environment of the communication terminal are observed. Consequently, handover can be realized in consideration of not only the reception environment of the communication terminal itself but also situations of the other party of communication.

### BRIEF DESCRIPTION OF THE DRAWINGS

FIG. 1 is a diagram showing outline of access point switching in a communication system using a wireless LAN.

FIG. 2 is a block diagram showing outline of a circuit configuration of a wireless LAN terminal in an embodiment.

FIG. 3 is a characteristic diagram showing the relation between distance to an access point of a wireless LAN terminal and travel speed of the wireless LAN terminal itself in the embodiment.

FIG. 4 is an explanatory diagram showing the case where one threshold is provided for reception level and transmission packet error rate.

FIG. 5 is an explanatory diagram showing the case where two thresholds are provided in the embodiment.

FIG. 6 is an explanatory diagram showing the content of a threshold setting table in the embodiment.

FIG. 7 is a flowchart showing the state of calculation of the fluctuation rate of the reception level and transmission packet error rate in the wireless LAN terminal in the embodiment.

FIG. 8 is a flowchart showing the state of execution of handover based on a scan trigger in the wireless LAN terminal in the embodiment.

FIG. 9 is an explanatory diagram showing the possibility of use of various communication parameters as modification possibility of the present invention.

FIG. 10 is a flowchart showing an access point switch controlling method which is conventionally proposed.

FIG. 11 is a characteristic diagram showing the relation between distance from an access point and reception level.

FIG. 12 is a block diagram showing outline of a circuit configuration of a wireless LAN terminal in the embodiment.

### DESCRIPTION OF REFERENCE NUMERALS

201 LAN cable
202 access point
203 wireless LAN terminal
211 control unit
212 CPU
213 ROM
213T threshold setting table
214 RAM
219 transmission packet error rate measuring unit
220 re-transmission rate measuring unit
221 re-reception rate measuring unit
222 reception level measuring unit
223 scanning unit
224 handover unit
243 scan trigger threshold
244 handover trigger threshold

### BEST MODE FOR CARRYING OUT THE INVENTION

The present invention will be described in detail below by the embodiments. In the following embodiments, reception environment information (communication parameters indicative of reception environments) will be described in the case of using reception level, re-reception rate, or reception packet error rate. Transmission environment information (communication parameters indicative of transmission environments) will be described in the case of using transmission packet error rate, re-transmission rate, or transmission transfer rate.

### First Embodiment

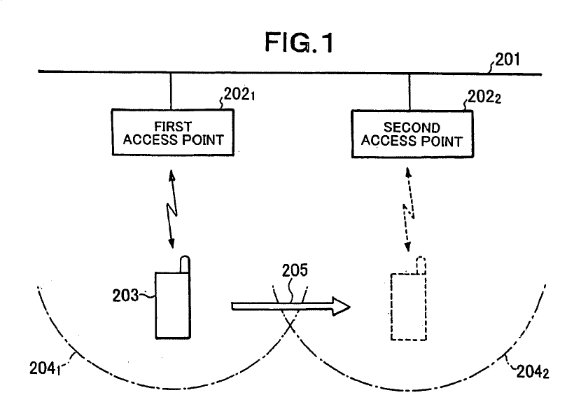

FIG. 1 is a diagram showing outline of access point switching in a communication system using a wireless LAN. The communication system shown in FIG. 1 has first and second access points 202₁ and 202₂ connected to a LAN cable 201. A wireless LAN terminal 203 as a communication terminal belongs to a valid service area 204₁ of the first access point 202₁ but searches for the next access point since it travels in the direction of an arrow 205. Using the result of the search, the wireless LAN terminal 203 is handed over to a valid service area 204₂ of the second access point 202₂.

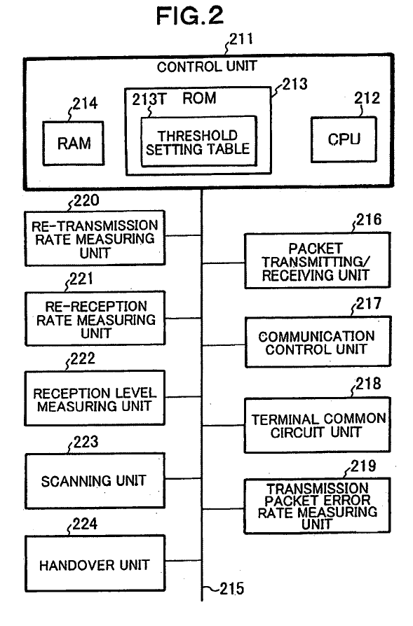

FIG. 2 shows outline of a circuit configuration of the wireless LAN terminal of the embodiment. The wireless LAN terminal 203 has a control unit 211 for performing general control. The control unit 211 has a CPU (Central Processing Unit) 212, a ROM (Read Only Memory) 213 storing a control program to be executed by the CPU 212 and fixed data, and a RAM (Random Access Memory) 214 for temporarily storing various data used for executing the control program. A part of the RAM 214 may be also constructed as a nonvolatile memory by being backed up by a not shown battery. An example of the fixed data stored in the ROM 213 is a threshold setting table 213T. The threshold setting table is provided as necessary. The case of using the threshold setting table 213T will be described later. The control unit 211 is connected to elements in the wireless LAN terminal 203 via a bus 215 as signal transmitting means as will be described later.

A packet transmitting/receiving unit 216 as one of the elements transmits/receives packets to/from an access point such as the first access point 202₁ shown in FIG. 1. A communication control unit 217 performs communication control at the time of transmitting/receiving packets. A terminal common circuit unit 218 is a common circuit part of the terminal excluding a circuit part having unique functions of the embodiment in the wireless LAN terminal 203. The common circuit part includes, for example, a data input unit having an operation panel and an output unit having an image output display.

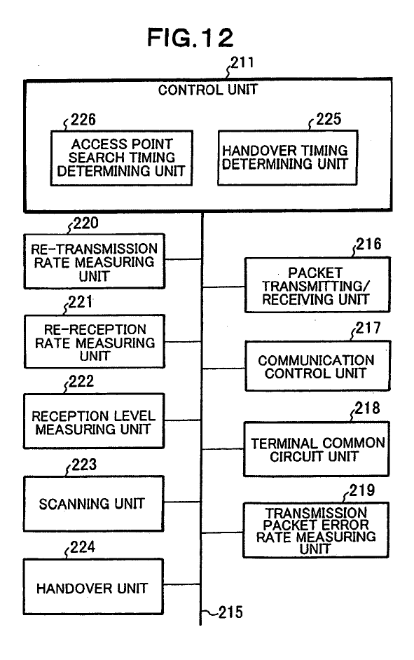

A transmission packet error rate measuring unit 219 measures the ratio of packets requested to be retransmitted due to occurrence of an error to the total number of packets transmitted from the wireless LAN terminal 203. A re-transmission rate measuring unit 220 measures the ratio of retransmitted packets to the transmitted packets. A re-reception rate measuring unit 221 measures the ratio of packets requested to be retransmitted to reception packets. A reception level measuring unit 222 measures the reception level of an electric wave. In order to determine whether handover is performed or not, a scanning unit 223 makes the reception level measuring unit 222 start/finish checking of the reception level and makes the transmission packet error rate measuring unit 219, re-transmission rate measuring unit 220, or re-reception rate measuring unit 221 start/finish measurement as necessary. Therefore, the longer the duration of activation of the scanning unit 223 is, the more the process of the wireless LAN terminal 203 increases and the more power is consumed. A handover unit 224 selects an access point to which the wireless LAN terminal 203 is to be switched on the basis of the search result of the scanning unit 223 and performs handover as a switching process. The scanning unit 223 serves as an access point searching unit that searches for an access point to which the wireless LAN terminal 203 is to be switched. The control unit 211 has the function of an access point search timing determining unit 226 for determining a timing of searching for an access point to which the wireless LAN terminal 203 is to be switched, shown in FIG. 12. For example, as shown in FIG. 4, when the reception level is smaller than a scan trigger threshold or the transmission packet error rate is larger than the scan trigger threshold, the control unit 211 controls start of the scanning unit 223 and determines a timing of searching for an access point.

The control unit 211 has the function of a handover timing determining unit 225 for determining a timing of handover to the access point to which the wireless LAN terminal 203 is to be switched, shown in FIG. 12. For example, as shown in FIG. 4, when the reception level is smaller than a handover trigger threshold or the transmission packet error rate is larger than the handover trigger threshold, the control unit 211 controls start of the handover unit 224 and determines a timing of handover.

The units 216 to 224 except for the control unit 211 may be constructed by hardware. At least a part of the units 216 to 224 may be also realized by software. In the latter case, the circuits are realized by software when the CPU 212 in the control unit 211 executes the control program stored in the ROM 212. The transmission packet error rate measuring unit 219 and the re-transmission rate measuring unit 220 correspond to a transmission environment information measuring unit, and the re-reception rate measuring unit 221 and the reception level measuring unit 222 correspond to a reception environment information measuring unit. The transmission packet error rate measuring unit 219, the re-transmission rate measuring unit 220, the re-reception rate measuring unit 221, and the reception level measuring unit 222 are provided as necessary. For example, in the case where the scan start control is performed with the scan trigger threshold of the reception level and transmission packet error rate, and the handover start control is performed with the handover trigger threshold of the reception level and transmission packet error rate, the re-transmission rate measuring unit 220 and the re-reception rate measuring unit 221 may not be provided. As necessary, a measuring unit for measuring other reception environment information or transmission environment information may be added.

FIG. 4 is a diagram showing the case where one threshold is provided for the reception level and the transmission packet error rate. The vertical axis expresses reception level of the wireless LAN terminal 203, and the horizontal axis expresses the transmission packet error rate. One scan trigger threshold 243 and one handover trigger threshold 244 are set between a good communication area 241 close to an access point and a poor communication area 242 far from an access point.

In the embodiment, the scan trigger threshold 243 and the handover trigger threshold 244 are set for the reception level and the transmission packet error rate. Consequently, when the transmission packet error rate becomes larger than the scan trigger threshold 243 even if the reception level does not change, the scanning unit 223 is started. When the transmission packet error rate becomes larger than the handover trigger threshold, handover is carried out. When the reception level becomes smaller than the scan trigger threshold 243 even if the transmission packet error rate does not change, the scanning unit 223 is started. When the reception level becomes smaller than the handover trigger threshold, handover is performed.

For example, in the case where another communication terminal for performing transmission at the same frequency as that of the communication terminal itself exists near an access point, the reception level itself of a signal received from the access point at the terminal itself does not change. However, transmission of the terminal itself is disturbed by transmission of the another communication terminal, and the transmission packet error rate becomes high. In the embodiment, even in such situations, optimum handover can be realized in consideration of also the situations on the other side of the communication.

However, predetermined time is required for each of the scanning process by the scanning unit 223 and the handover process by the handover unit 224 shown in FIG. 2. Therefore, when the wireless IAN terminal 203 shown in FIG. 1 existing in the good communication area 241 travels toward the poor communication area 242, depending on the travel speed and a change in the communication environment, there is the possibility that the wireless LAN terminal 203 travels to the poor communication area 242 before handover is carried out, and enters a communication disable state.

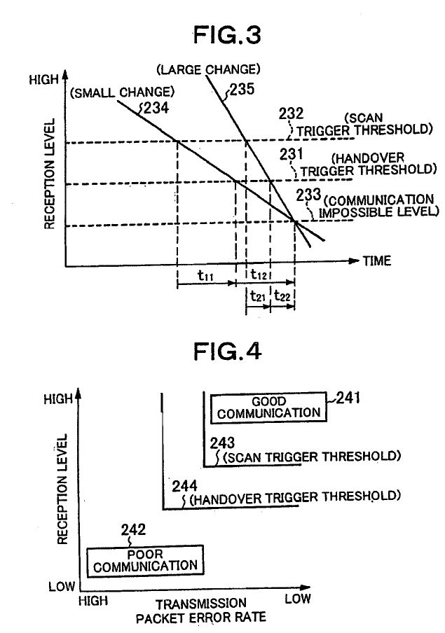

A change in the reception level will be described as an example below. FIG. 3 shows the relation between the reception level in the wireless LAN terminal and time. In the diagram, the vertical axis expresses the reception level of the wireless LAN terminal 203 shown in FIG. 1, and the horizontal axis expresses lapse of time. The distance to an access point from the wireless LAN terminal exerts an influence on the reception level, and a change in the reception level to unit time corresponds to travel speed of the wireless LAN terminal itself. A threshold for starting handover is set as a handover trigger threshold 231. A value increased from the threshold only by a predetermined value is set as a scan trigger threshold 232 for starting a search for an access point. The scan trigger threshold 232 can be set by using arbitrary one of various communication parameters such as the reception level from each of access points and the transmission packet error rate.

It is now assumed that the wireless LAN terminal 203 exists near the first access point 202₁ in FIG. 1 and travels (moves) away. At the initial point, the reception level measuring unit 222 shown in FIG. 2 measures a reception level higher than the scan trigger threshold 232 shown in FIG. 3. As the wireless LAN terminal 203 travels away from the first access point 202₁, at a certain time point, the reception level measuring unit 222 measures the reception level equal to or lower than the scan trigger threshold 232. When the wireless LAN terminal 203 further travels away from the first access point 202₁, in the case where the handover is not performed for a reason such that another access point cannot be found, the reception level drops to a reception level 233 shown in FIG. 3 at which communication cannot be performed with the present access point.

A change per unit time in the travel amount when the wireless LAN terminal 203 travels away from the first access point 202₁ at constant speed will be considered. A first linear line 234 shown in FIG. 3 indicates the case where a change in the travel amount per unit time is small, that is, the case where the travel speed of the communication terminal is low. On the other hand, a second linear line 235 indicates the case where a change in the travel amount per unit time is large, that is, the travel speed of the communication terminal is high. In the case of the first linear line 234, both of time till from the scan trigger threshold 232 to the handover trigger threshold 231 and time t12 from the handover trigger 231 to the reception level 233 of the communication disable state is sufficiently long. In contrast, in the case of the second linear line 235, both of time t21 from the scan trigger threshold 232 to the handover trigger threshold 231 and time t22 from the handover trigger 231 to the reception level 233 of the communication disable state is shorter than that in the case of the first linear line 234.

As a result, in the case where the two thresholds 231 and 232 are fixed, when the travel speed of the wireless LAN terminal 203 increases and the communication environment changes, there is the possibility that the reception level decreases to the reception level 233 of the communication disable state before handover to another access point is actually performed.

Although FIG. 3 shows the case using the reception level, the other wireless communication parameters such as the transmission packet error rate, re-transmission rate, and re-reception rate may be similarly used except for the following point. The higher the reception level is, the lower each of the transmission packet error rate, re-transmission rate, and re-reception rate is. The lower the reception level is, the higher the rates are.

Also in the case of using any of the wireless communication parameters, when the degree of a change per unit time of the travel amount when the wireless LAN terminal 203 travels away from the first access point 2021 varies, the time required for the reception level to drop to the reception level 233 of the communication disable state varies. Therefore, in the case where the two thresholds 231 and 232 are fixed, when the wireless LAN terminal 203 is traveling or wireless environment changes, it becomes difficult to promptly react to search for the next access point. In addition, since the reception level is used as the trigger of the access point, there is the case such that the wireless LAN terminal cannot accommodate to variations in the reception characteristic or the transmission characteristic of the wireless LAN terminal 203 or access point.

In the embodiment, it is therefore preferable to use a combination of the reception level as a communication parameter on the down (reception) side and transmission packet error rate as a communication parameter of the up (transmission) side and use handover trigger thresholds 231 and scan trigger thresholds 232 shown in FIG. 3 in two stages. Although the thresholds are set in two stages, it is for convenience of the description of the embodiment. In practice, thresholds in multiple stages may be used. The wireless LAN terminal 203 monitors the degree of a change in the wireless communication parameters and, according to the degree, properly uses the thresholds in two stages. Although the rate of a change (fluctuation rate) of the reception level is used as the degree of a change in the wireless communication parameter, the rate of a change (fluctuation rate) of any of the other wireless communication parameters indicative of transmission environment or reception environment such as the transmission packet error rate, re-transmission rate, and re-reception rate may be used.

FIG. 5 shows the case where thresholds in two stages are set in the embodiment. The vertical axis expresses the reception level of the wireless LAN terminal 203, and the horizontal axis expresses the transmission packet error rate. A second scan trigger threshold 243₂ is set closest to the good communication area 241. Toward the poor communication area 242, a first scan trigger threshold 243₁, a second handover trigger threshold 244₂, and a first handover trigger threshold 244₁ are set in order.

As a result, for example, when the wireless LAN terminal 203 travels (moves) away from the first access point 202₁, the control unit 211 shown in FIG. 2 measures the reception level by the reception level measuring unit 222, and measures the transmission packet error rate by the transmission packet error rate measuring unit 219. In the case where a change with time of the reception level is large and the transmission packet error rate itself is also high, to assure time for a process, the second scan trigger threshold 234₂ and second handover trigger threshold 244₂ are selected as thresholds. Different from the above, in the case where a change with time of the reception level is small and the transmission packet error rate itself is low, the first scan trigger threshold 234₁ and first handover trigger threshold 244ᵢ are selected as thresholds.

There is also the case where the transmission packet error rate itself is low though a change with time of the reception level is large and, on the contrary, the case where the transmission packet error rate itself is high through a change with time of the reception level is small. In those cases, it is an issue to employ which threshold. In such a case, the thresholds are set using communication parameters of the fluctuation rate of the reception level and the transmission packet error rate. The threshold setting table 213T shown in FIG. 2 is used for this purpose.

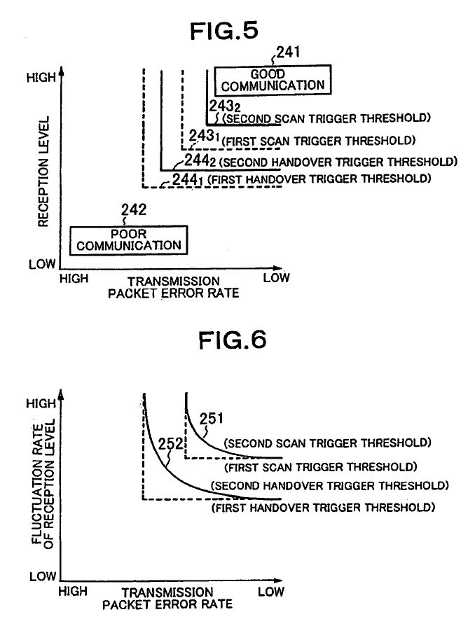

FIG. 6 shows the content of the threshold setting table. Description will be given also with reference to FIG. 5. In the threshold setting table 213T, the fluctuation rate of the reception level of the wireless LAN terminal 203 and the transmission packet error rate are entered. When the cross point of them is higher than a scan trigger threshold determination curve 251, the second scan trigger threshold 243₂ is set. Specifically, in the case where the fluctuation rate of the reception level is very high and the transmission packet error rate is very low, the second scan trigger threshold 243₂ and the second handover trigger threshold 244₂ are set. In this case, the scanning unit 223 shown in FIG. 2 starts scanning of the reception level from a stage of a relatively high reception level and, similarly, handover is performed from a stage of a relatively high reception level. Therefore, even when the travel speed of the wireless LAN terminal 203 is high, the handover process is performed at the early stage, and the danger that communication is disabled is reduced.

On the contrary, when the fluctuation rate of the reception level of the wireless LAN terminal 203 and the transmission packet error rate are entered and the cross point of them is below a scan trigger threshold determination curve 252, the first scan trigger threshold 243₁ and the first handover trigger threshold 244₁ are set. Specifically, in the case where the fluctuation rate of the reception level is very low and the transmission packet error rate is very high, the first scan trigger threshold 243₁ and the first handover trigger threshold 244₁ are set. In this case, the scanning unit 223 shown in FIG. 2 starts scanning of the reception level after the reception level becomes relatively low and, similarly, handover is performed after the reception level becomes relatively low. The reason is that, in the case where the travel speed of the wireless LAN terminal 203 is low, even when the handover process is performed late, the danger that communication is disabled is low, and power consumption of the wireless LAN terminal 203 is also reduced.

On the other hand, in the case where the cross point of the fluctuation rate of the reception level and the transmission packet error rate exists in an area below the scan trigger threshold determination curve 251 and higher than the handover trigger threshold determination curve 252, the first scan trigger threshold 243ᵢ and the second handover trigger threshold 244₂ are set. The start of the scan of the scanning unit 223 is not hastened but the handover trigger threshold itself is set to be high in order to realize both power saving and reliability of handover.

Depending on the configuration of an access point switching system 200 (FIG. 2), one threshold determination curve may be set in the threshold setting table 213T. In this case, either setting of the second scan trigger threshold 243₂ and the second handover trigger threshold 244₂ or setting of the first scan trigger threshold 243₁ and the first handover trigger threshold 244₁ is allowed to be selected depending on whether the fluctuation rate of the reception level and the transmission packet error rate are positioned on upper or lower side of the threshold determination curve.

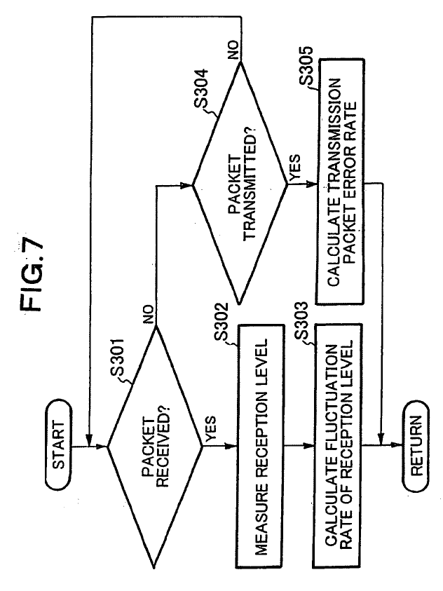

FIG. 7 shows a state of calculation of the reception level fluctuation rate and the transmission packet error rate in the wireless LAN terminal. This is a process as the base of calculation of the scan trigger threshold and the handover trigger threshold. The process will be described also with reference to FIG. 2. When the packet transmitting/receiving unit 216 receives a packet (YES in step S301), the wireless LAN terminal 203 measures the reception level at that time point by the reception level measuring unit 222 (step S302). By comparing the measured reception level with the reception levels in the past, the fluctuation rate of the reception level is calculated (step S303).

When the packet transmitting/receiving unit 216 transmits a packet (NO in step S301 and YES in step S304), the ratio of re-transmitted packets to the transmitted packets, that is, the transmission packet error rate is calculated (step S305). The calculation results are sequentially overwritten in the predetermined area in the RAM 214. That is, the latest reception level fluctuation rate and the latest transmission packet error rate are recorded in the area in the RAM 214.

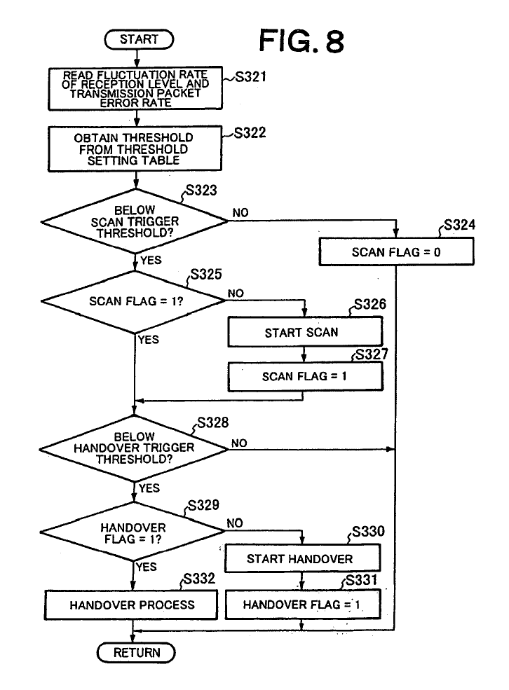

FIG. 8 shows the state of execution of handover based on a scan trigger of the wireless LAN terminal. The process is executed by the control unit 211 shown in FIG. 2 in predetermined cycles. The process will be described also with reference to FIG. 2. First, the control unit 211 reads the latest reception level fluctuation rate and the latest transmission packet error rate written in the predetermined area in the RAM 214 by the process described with reference to FIG. 7 (step S321). The control unit 211 obtains the scan trigger threshold 243 and the handover trigger threshold 244 by using the threshold setting table 213T (step S322). That is, at this stage, the first scan trigger threshold 243₁ or the second scan trigger threshold 243₂, and the first handover trigger threshold 244₁ or the second handover trigger threshold 244₂ are determined.

Next, the control unit 211 determines whether or not the combination of the reception level fluctuation rate and the transmission packet error rate at present is less than the scan trigger threshold (step S323). The scan trigger threshold is the first scan trigger threshold 243₁ or the second scan trigger threshold 243₂ determined in step S322. When the combination is equal to or higher than the scan trigger threshold (NO in step S323), a scan flag is set to “0” (step S324). The scan flag is a flag for determining which a scan is already executed or not. When “1” is set for the scan flag, it expresses that a scan is being executed. When “0” is set for the scan flag, it means that it is unnecessary to perform a scan. In this case, the series of processes is finished (return).

On the other hand, when the combination is less than the scan trigger threshold (YES in step S323), a check is made to see whether “1” is set for the scan flag at present or not (step S325). When “1” is not set for the scan flag (NO), it means that the scanning unit 223 has not performed a scan yet. In this case, a scan is started (step S326) and the scan flag is changed to “1” (step S327). The control unit 211 moves to the next step S328. When “1” is set for the present scan flag in step S325 (YES), the control unit 211 moves directly to step S328.

In step S328, whether the combination is less than the handover trigger threshold or not is determined. The handover trigger threshold is the first handover trigger threshold 244₁ or the second handover trigger threshold 244₂ determined in step S322. When the combination is not less than the handover trigger threshold (NO), the process is finished without performing the handover process (return).

In the case where the combination is less than the handover trigger threshold (YES in step S328), a check is made to see whether “1” is set for the handover flag or not (step S329). The handover flag is a flag for determining which the handover process is already executed or not. When “1” is set for the handover flag, it expresses that the handover is being executed.

In the case where “0” is set for the handover flag (NO), the handover process has not started yet. In this case, handover is started (step S330), and “1” is set for the handover flag (step S331). In the case where “1” is set for the handover flag (YES in step S329), the handover process is continued (step S332).

A concrete example will be described. As shown in FIG. 1, it is assumed that the wireless LAN terminal 203 travels rapidly from an area near the first access point 202₁ toward the second access point 202₂. When it is assumed that the transmission packet error rate is about normal one, the reception level fluctuation rate is high. Consequently, the second scan trigger threshold 243₂ and the second handover trigger threshold 244₂ are selected in step S322 in FIG. 8. Therefore, the scanning unit 223 starts a scan of the reception level of electric wave by using the second scan trigger threshold 243₂ earlier than the case where the first scan trigger threshold 243₁ is set. The handover process to the second access point 202₂ is started with the second handover trigger threshold 244₂ earlier than the case where the first handover trigger threshold 244₁ is set. As a result, the situation such that the communication is disabled due to delay in the start of the handover process can be avoided.

On the other hand, when the wireless LAN terminal 203 travels at relatively low speed from an area near the first access point 202₁ toward the second access point 202₂, the first scan trigger threshold 243₁ and the first handover trigger threshold 244₁ are selected in step S322. Therefore, the scanning unit 223 starts a scan of the reception level of electric wave by using the first scan trigger threshold 243₁ later than the case where the second scan trigger threshold 243₂ is set. The handover process to the first access point 202₁ is started with the first handover trigger threshold 244₁ later than the case where the second handover trigger threshold 244₂ is set. As a result, the process of the wireless LAN terminal 203 is reduced, and power consumption can be reduced.

It is also assumed that the wireless LAN terminal 203 travels at normal speed from an area near the first access point 202₁ toward the second access point 202₂, the communication environment is bad, and the transmission packet error rate is high. In such a case, the second scan trigger threshold 243₂ and the second handover trigger threshold 244₂ are selected in step S322 in FIG. 8. Therefore, the scanning unit 223 starts a scan of the reception level of electric wave from each of access points by using the second scan trigger threshold 243₂ earlier than the case where the first scan trigger threshold 243₁ is set. The handover process to the second access point 202₂ is started with the second handover trigger threshold 244₂ earlier than the case where the first handover trigger threshold 244₁ is set. As described above, even when the communication environment is bad, selection of an access point at a switch destination and the handover process can be started in good time. Therefore, a situation such that no handover is performed and the communication is disabled can be avoided more reliably.

The case where the travel speed of the wireless LAN terminal 203 is high and the special case where the communication environment is bad and the transmission packet error rate is high have been concretely described above. Also for various combinations between the travel speed of reception environment information or transmission environment information and the communication environment (the reception environment information or transmission environment information), handover can be performed more preferably as compared with the conventional technique. This will not be described.

### Second Embodiment

In the foregoing embodiment, the threshold for handover is adjusted by using the two communication parameters of the reception level fluctuation rate and the transmission packet error rate. However, the invention is not limited to the embodiment. By using the re-transmission rate measuring unit 220 and the re-reception rate measuring unit 221 shown in FIG. 2 instead or combining them with the reception level and the transmission packet error rate, high-reliability handover control can be similarly performed.

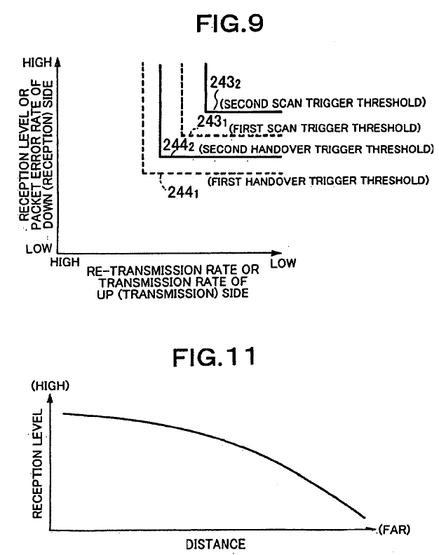

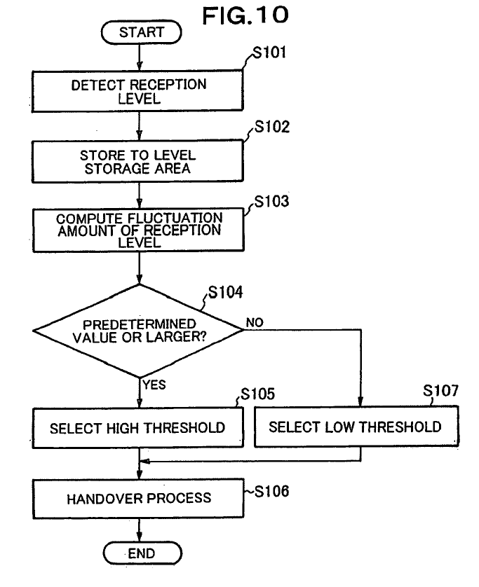

FIG. 9 corresponds to FIG. 5 and shows that either the reception level or the packet error rate can be employed for the down (reception) side and either the number of re-transmission times, re-transmission rate, or transmission rate can be employed for the up (transmission) side. The user can most effectively set thresholds for a scan trigger and a handover trigger by arbitrarily combining the communication parameters. Obviously, communication parameters other than the above may be used as communication parameters for setting thresholds. The wireless LAN terminal 203 of FIG. 2 described in the embodiment has the re-transmission rate measuring unit 220 and the re-reception rate measuring unit 221 in addition to the transmission packet error rate measuring unit 219 and the reception level measuring unit 222 on the precondition that the communication parameters are arbitrarily combined. In FIG. 9, the reception level itself is used for adjusting the threshold. As described in the embodiment, obviously, the fluctuation rate of the reception level may be used instead. Specifically, in the case of selecting the scan trigger threshold and the handover threshold, in place of using the fluctuation rates of parameters indicative of reception environment and transmission environment, parameters (reception level and transmission packet error rate) indicative of the reception environment and the transmission environment may be used. In the case of selecting the scan trigger threshold and the handover threshold, two fluctuation rates of parameters indicative of reception environment and transmission environment, for example, the fluctuation rate of the reception level and that of the transmission packet error rate may be used.

As shown in FIG. 9, by setting the scan trigger threshold and the handover trigger threshold by a combination of the communication parameters of the up (transmission) side and the down (reception) side, an access point can be searched more reliably under various communication environments of different reception characteristics and transmission characteristics.

Each of the number of the up (transmission) communication parameter and the number of the down (reception) communication parameter is not limited to one. It is also possible to add a plurality of communication parameters while being weighted for each of the up (transmission) side and the down (reception) side and set a threshold for a combined communication parameter. Consequently, the state of the wireless LAN terminal 203 can be accurately grasped, and handover can be performed reliably. By properly setting a scan trigger, the embodiment can contribute to power saving of particularly a portable communication terminal.

Although switching of an access point in a wireless LAN terminal using a wireless LAN has been described in the first and second embodiments, naturally, the present invention can be applied generally to communication terminals for performing communications by radio while determining an access point from a plurality of access points.

In the case of realizing switching of an access point according to the present invention by a program using a computer as a wireless LAN terminal, the present invention is realized as a program product stored in a ROM as a storage portion of a computer and having a code for making the computer execute the access point switching method described with reference to FIGS. 7 and 8. The computer can be constructed by a CPU, a ROM, a RAM, a data input unit having an operation panel, an output unit having a display for outputting an image, and a data bus connecting the elements. A ROM, a flash memory, a DVD, and the like as computer readable media that stores the program for executing the access point switching method described with reference to FIGS. 7 and 8 are also included in the scope of right of the present invention. The right of the present invention includes the program itself. In the case of downloading the program to a communication terminal via an access point, the right of the invention also includes the act of transmitting/receiving the program.

In the foregoing first and second embodiments, the reception environment information and the transmission environment information of the wireless LAN terminal whose access point is to be switched is measured, and measurement results are combined. The combination of the measurement results is used to search an access point to be switched of the wireless LAN terminal and to perform the handover. Conventionally, only the reception level of the wireless LAN terminal is checked, so that only a part of the reception environment information is checked. In the present embodiment, both the reception environment information and the transmission environment information is checked. Therefore, fluctuations in the various communication environments can be grasped more accurately, and a timing of searching for an access point and a timing of the handover can be set, so that reliability of the access point switching improves. By observing the communication environment by its fluctuation rate, whether or not it is necessary to promptly search for an access point and handover can be determined. A situation such that handover fails and communication is disabled can be effectively avoided.

The present invention can be variously modified without departing from the spirit or main features thereof. It is therefore to be understood that the foregoing embodiments are illustrative and not restrictive. The scope of the invention is defined by the scope of claims and is not limited by the description and the abstract. Further, all modifications and changes belonging to the equivalent scope of the scope of claims of the present invention are within the scope of the present invention.

1. A communication terminal comprising:
a reception environment information measuring unit for measuring information of reception environment between the communication terminal and an access point;
a transmission environment information measuring unit for measuring information of transmission environment between the communication terminal and the access point;
an access point search timing determining unit for determining a timing of searching for an access point to be switched by using a combination of the reception environment information measured by the reception environment information measuring unit and the transmission environment information measured by the transmission environment information measuring unit;
an access point searching unit for searching for the access point to be switched at the access point search timing determined by the access point search timing determining unit;
a handover timing determining unit for determining a timing of handover to the access point to be switched by using a combination of the reception environment information measured by the reception environment information measuring unit and the transmission environment information measured by the transmission environment information measuring unit; and
a handover unit for performing handover to the access point searched by the access point searching unit at the handover timing determined by the handover timing determining unit.

2. The communication terminal according to claim 1, wherein the reception environment information is at least one of reception level, re-reception rate, and reception packet error rate.

3. The communication terminal according to claim 1, wherein the transmission environment information is at least one of transmission packet error rate, retransmission rate, and transmission rate.

4. The communication terminal according to claim 1, wherein a determination criterion of each of the access point search timing determining unit and the handover timing determining unit is set in a plurality of stages.

5. The communication terminal according to claim 4, wherein the determination criterion which is set in plurality of stages is determined on the basis of fluctuation rate of the reception environment information or fluctuation rate of the transmission environment information.

6. The communication terminal according to claim 4, wherein the determination criterion which is set in a plurality of stages is determined on the basis of the fluctuation rate of the reception environment information and the transmission environment information, or the reception environment information and the fluctuation rate of the transmission environment information.

7. The communication terminal according to claim 4, wherein the determination criterion which is set in a plurality of stages is determined on the basis of the reception environment information, the transmission environment information, or a combination of the reception environment information and the transmission environment information.

8. The communication terminal according to claim 5, wherein the higher the fluctuation rate of the reception environment information or the fluctuation rate of the transmission environment information is, the longer time allowance of the determination criterion of the access point search timing determining means and the handover timing determining means is.

9. The communication terminal according to claim 1, wherein each of the reception environment information and the transmission environment information is constructed by arbitrary number of communication parameters indicative of the corresponding environment, predetermined weights are applied to the communication parameters of each of the environments, and the weighted communication parameters are combined.

10. A method of switching an access point in a communication terminal, comprising:
a reception environment information measuring process for measuring information of reception environment between the communication terminal and the access point;
a transmission environment information measuring process for measuring information of transmission environment between the communication terminal and the access point;
an access point search timing determining process for determining a timing of searching for an access point to which the communication terminal is to be switched by using a combination of the reception environment information measured in the reception environment information measuring process and the transmission environment information measured in the transmission environment information measuring process;
an access point searching process for searching for the access point to which the communication terminal is to be switched at the determined access point searching timing;
a handover timing determining process for determining a timing of handover to the access point to which the communication terminal is to be switched by using a combination of the reception environment information measured in the reception environment information measuring process and the transmission environment information measured in the transmission environment information measuring process; and
a handover process for performing handover to the access point searched by the access point searching process at the handover timing determined by the handover timing determining process.

11. The access point switching method according to claim 10, wherein the reception environment information is at least one of reception level, re-reception rate, and reception packet error rate.

12. The access point switching method according to claim 10, wherein the transmission environment information is at least one of transmission packet error rate, re-transmission rate, and transmission rate.

13. The access point switching method according to claim 10, wherein a determination criterion of each of the access point search timing determining unit and the handover timing determining unit is set in a plurality of stages.

14. The access point switching method according to claim 13, wherein the determination criterion which is set in plurality of stages is determined on the basis of fluctuation rate of the reception environment information or fluctuation rate of the transmission environment information.

15. The access point switching method according to claim 13, wherein the determination criterion which is set in a plurality of stages is determined on the basis of the fluctuation rate of the reception environment information and the transmission environment information, or the reception environment information and the fluctuation rate of the transmission environment information.

16. The access point switching method according to claim 14, wherein the higher the fluctuation rate of the reception environment information or the fluctuation rate of the transmission environment information is, the longer time allowance of the determination criterion of the access point search timing determining means and the handover timing determining means is.

17. The access point switching method according to claim 10, wherein each of the reception environment information and the transmission environment information is constructed by arbitrary number of communication parameters indicative of the corresponding environment, predetermined weights are applied to the communication parameters of each of the environments, and the weighted communication parameters are combined.

18. An access point switching control program for making a computer as a communication terminal for performing communication with an access point execute:
a reception environment information measuring process for measuring information of reception environment between the communication terminal and the access point;
a transmission environment information measuring process for measuring information of transmission environment between the communication terminal and the access point;
an access point search timing determining process for determining a timing of searching for an access point to which the communication terminal is to be switched by using a combination of the reception environment information measured in the reception environment information measuring process and the transmission environment information measured in the transmission environment information measuring process;
an access point searching process for searching for the access point to which the communication terminal is to be switched at the determined access point search timing;
a handover timing determining process for determining a timing of handover to the access point to which the communication terminal is to be switched by using a combination of the reception environment information measured in the reception environment information measuring process and the transmission environment information measured in the transmission environment information measuring process; and
a handover process for performing handover to the access point searched by the access point searching process at the handover timing determined by the handover timing determining process.
